(19) United States
(12) Patent Application Publication
(10) Pub. No.: US 2013/0311373 A1
(43) Pub. Date: Nov. 21, 2013

(54) APPARATUS AND METHOD FOR PAYING FOR A PRODUCT USING A NEAR FIELD COMMUNICATION DEVICE

(71) Applicant: Samsung Electronics Co., Ltd., Gyeonggi-do (KR)

(72) Inventors: Kyu-Hui HAN, Daegu (KR); Jun-Kyoung SHIN, Gyeongsangbuk-do (KR); Dae-Haeng CHO, Gyeongsangbuk-do (KR)

(73) Assignee: Samsung Electronics Co., Ltd., Gyeonggi-do (KR)

(21) Appl. No.: 13/895,467

(22) Filed: May 16, 2013

(30) Foreign Application Priority Data
May 18, 2012 (KR) 10-2012-053123

(51) Int. Cl. G06Q 20/32

(52) U.S. Cl. CPC G06Q 20/3278
USPC 705/44

(57) ABSTRACT

An apparatus and a method perform paying for a product using a near field communication device. The method includes: when payment for a particular product is requested by a user, generating a payment request message for requesting payment for the particular product and transmitting the payment request message to a security element server; when a personal identification information request message for requesting personal identification information in response to the payment request message is received, receiving an input of personal identification information from the user; transmitting the input personal identification information to the security element server; and receiving a payment result message representing a result of the payment.

### CLAIM OF PRIORITY

This application claims, pursuant to 35 U.S.C. §119(a), priority to and the benefit of the earlier filing date of Korean Application Serial No. 10-2012-0053123, which was filed in the Korean Intellectual Property Office on May 18, 2012, the entire contents of which is hereby incorporated by reference.

### BACKGROUND OF THE INVENTION

1. Field of the Invention

The present invention generally relates to a near field communication device, and more particularly, to an apparatus and a method for paying for a product using a near field communication device.

2. Description of the Related Art

A near field communication (NFC) device may provide various services according to developments of near field communication device technology. In particular, a service provided through a near field communication device in the prior art includes a card mode for performing functions such as credit card transactions and transportation card transactions. To perform the card mode, a security element for encoding a user related information and storing the information is required.

As described above, the near field communication device in the prior art performs the card mode by using a security element previously stored internally. However, a method as described above has a problem in that the near field communication device in the prior art should have a new security element installed in case the near field communication device becomes lost. In addition, there is a problem in that a person who has acquired the lost near field communication device in the prior art may be able to gain unauthorized access to user-related information by analyzing and hacking the security element. Thus, a method for solving such problems has become necessary.

### SUMMARY OF THE INVENTION

The present invention is to provide an apparatus and a method capable of performing payment for a product even though a near field communication device does not store a security element.

In accordance with an aspect of the present invention, there is provided an apparatus for paying for a product using a near field communication device. The apparatus includes: a controller for generating a payment request message for requesting payment for the particular product and then transmitting the payment request message to a security element server when payment for a particular product is requested by a user, receiving an input of personal identification information from the user and transmitting the input personal identification information to the security element server when a personal identification information request message for requesting personal identification information in response to the payment request message is received, and receiving a payment result message representing a result of the payment.

In accordance with another aspect of the present invention, there is provided an apparatus for paying for a product using a near field communication device. The apparatus includes: a memory unit for storing security elements corresponding to a plurality of portable terminals, and a controller for detecting a security element corresponding to the portable terminal among the security elements and determining whether the payment is authorized by using the detected security element when a payment request message for requesting payment for a particular product is received from a portable terminal, transmitting a personal identification information request message for requesting personal identification information to the portable terminal when an authentication of payment is determined, progressing payment for the particular product by using the personal identification information when the personal identification information is received, and transmitting a payment result message representing a result of the progressed payment to the portable terminal.

In accordance with another aspect of the present invention, there is provided a method of paying for a product using a near field communication device. The method includes: when payment for a particular product is requested by a user, generating a payment request message for requesting payment for the particular product and transmitting the payment request message to a security element server; when a personal identification information request message for requesting personal identification information in response to the payment request message is received, receiving an input of personal identification information from the user; transmitting the input personal identification information to the security element server; and receiving a payment result message representing a result of the payment.

In accordance with another aspect of the present invention, there is provided a method of paying for a product using a near field communication device. The method includes: when a payment request message for requesting payment for a particular product is received from a portable terminal, detecting a security element corresponding to the portable terminal among the previously stored security elements; determining whether the payment is authorized by using the detected security element; when the authentication of payment is determined, transmitting a personal identification information request message for requesting personal identification information to the portable terminal; when the personal identification information is received, progressing payment for the particular product by using the personal identification information; and transmitting a payment result message representing a result of the progressed payment to the portable terminal.

The present invention performs payment for a product by using a security element server for storing security elements of a plurality of portable terminals, and thus has an effect capable of performing payment for a product even though a near field communication device does not store a security element.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating an example implementation of a payment communication system according to an exemplary embodiment of the present invention;

FIG. 2 is a block diagram illustrating an example implementation of a portable terminal according to the exemplary embodiment of the present invention;

FIG. 3 is a block diagram illustrating an example implementation of a near field communication unit according to the exemplary embodiment of the present invention;

FIG. 4 is a flowchart illustrating a process of performing a payment according to the exemplary embodiment of the present invention;

FIG. 5 is a diagram illustrating an example implementation of a protocol data unit according to the exemplary embodiment of the present invention;

FIG. 6 is a diagram illustrating an example implementation of data for each message according to the exemplary embodiment of the present invention;

FIG. 7 is a flowchart illustrating a process by which a portable terminal pays for a product according to the exemplary embodiment of the present invention; and

FIG. 8 is a flowchart illustrating a process by which a security element server pays for a product according to the exemplary embodiment of the present invention.

### DETAILED DESCRIPTION OF THE PRESENT INVENTION

Hereinafter, various exemplary embodiments of the present invention will be described with reference to the accompanying drawings. Further, in the following description of the present invention, a detailed description of known functions and configurations incorporated herein will be omitted when it may make the subject matter of the present invention rather unclear. The present invention may, however, be embodied in many different forms and should not be construed as limited to the exemplary embodiments set forth herein. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

The same reference numbers are used throughout the drawings to refer to the same or like parts. Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, data refers to any kind of information processed by the device, including text and/or images received from any external entities, messages transmitted or received, and information created when a specific function is executed by the device.

A near field communication (NFC) device according to an exemplary embodiment of the present invention may be included in a portable terminal. The portable terminal may be an electronic apparatus that can be easily carried and/or worn, such as a video phone, a mobile phone, a smart phone, an international mobile telecommunication 2000 (IMT-2000) terminal, a WCDMA terminal, a Universal Mobile Telecommunication Service (UMTS) terminal, a Personal Digital Assistant (PDA), a Portable Multimedia Player (PMP), a Digital Multimedia Broadcasting (DMB) terminal, an E-book, a portable computer such as an electronic notebook, an electronic tablet, etc., a digital camera, and the like.

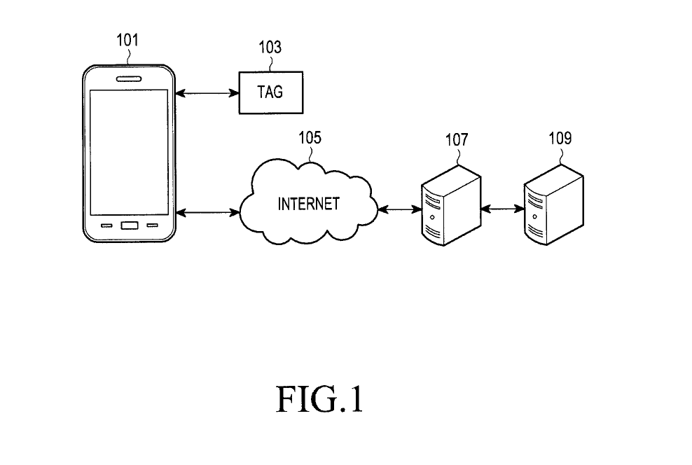

FIG. 1 is a diagram illustrating an example implementation of a payment communication system according to the exemplary embodiment of the present invention.

Referring to FIG. 1, a communication system includes a portable terminal 101, a tag 103, a wireless network such as at least the Internet 105, a security element server 107, and a payment server 109.

In particular, the tag 103 is attached to or located around a particular product and stores information (hereinafter, referred to as “product information”) for the particular product. The product information may include a product ID, a product price, a detailed description for a product, or the like. In addition, the product ID represents a unique ID assigned to or associated with the corresponding product. Meanwhile, product information stored in the tag 103 is read by the portable terminal 101 having any known technology for reading the product information from the tag 103, such as a radio frequency reader for reading a radio frequency identification (RFID) information stored in and transmitted by the tag 103, or a NFC reader for reading NFC-based information from the tag 103. The wireless network 105 is a connection media between the portable terminal 101 and the security element server 107 and transmits data received from the portable terminal 101 to the security element server 107 or transmits data received from the security element server 107 to the portable terminal 101.

In addition, when the payment server 109 receives a payment authentication message including user information of the portable terminal 101 and a product ID from the security element server 107, the payment server 109 determines whether payment for a product is allowed based on the received user information. When the payment is allowed, the payment server 109 transmits a payment allowance message representing that the payment for the product is allowed to the security element server 107. Moreover, when the payment server 109 receives personal identification information, the payment server 109 determines, by using the personal identification information, whether a user who requests payment is a user of the portable terminal 101. As a result of the determination, when it is determined that a user who requests payment is a user of the portable terminal 101, the payment server 109 performs payment for a product and transmits a payment result message representing a result of the performed payment to the security element server 107.

The security element server 107 stores, in a database, a plurality of security elements (hereinafter, referred to as “SE”) of a plurality of portable terminals. Then, the security element server 107 determines whether a payment request message is received from the portable terminal 101. The payment request message includes an identification (ID) or identifier of the portable terminal 101 and a product ID. As a result of the determination, when the payment request message is received, the security element server 107 detects a security element corresponding to the portable terminal 101 among security elements previously stored in the database by using the ID of the portable terminal 101 included in the payment request message, and transmits a payment authentication message including a user information included in the detected security element and a product ID to the payment server 109.

In addition, when the security element server 107 receives the payment allowance message from the payment server 109 in response to the payment authentication message, the security element server 107 transmits a personal identification information request message to the portable terminal 101 in order to determine whether a user who requests payment is a user of the portable terminal 101. The security element server 107 receives the personal identification information from the portable terminal 101 in response to the personal identification information request message. The personal identification information may include a personal identification number (hereinafter, referred to as “PIN”).

The security element server 107 transmits the received personal identification information to the payment server 109 and, when the security element server 107 receives the payment result message in response to the transmitted personal identification information, the security element server 107 transmits the received payment result message to the portable terminal 101. The payment result message is a message including a payment result representing that payment for a product corresponding to the product ID has succeeded or failed.

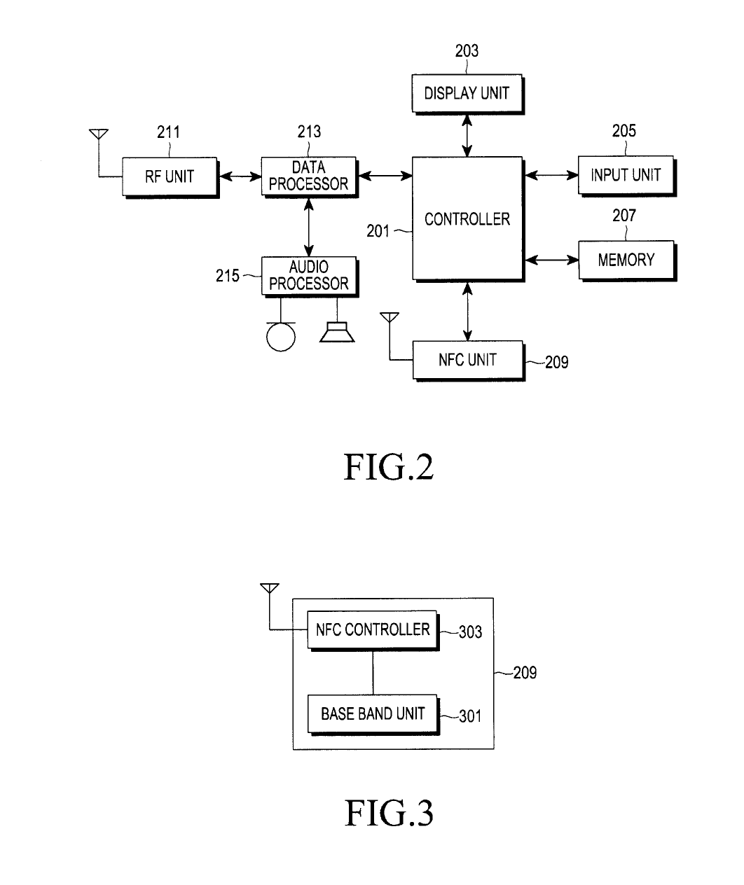

The portable terminal 101 determines whether the tag 103 is recognized within a near field communication area, such as within a predetermined range or radius from the tag 103. As a result of the determination, when the tag 103 is recognized, the portable terminal 101 reads product information from the tag 103 and generates a payment request message requesting payment for a particular product by using the read product information and then transmits the payment request message to the security element server 107. When the personal identification information request message is received from the security element server 107 in response to the payment request message, the portable terminal 101 displays a personal identification information input window on a display unit 203, as shown in FIG. 2. The personal identification information request message is a window to which a personal identification number is input by a user.

When the personal identification number is input through the personal identification information input window, the portable terminal 101 generates a personal identification information including the personal identification number and transmits the personal identification information to the security element server 107. Then the portable terminal 101 receives the payment result message from the security element server 107 and displays whether the payment for a product has succeeded or has failed after analyzing the received payment result message.

FIG. 2 is a block diagram illustrating an example implementation of the portable terminal 101 according to the exemplary embodiment of the present invention.

Referring to FIG. 2, the portable terminal 101 includes a controller 201, a display unit 203, an input unit 205, a memory unit 207, an NFC unit 209, an RF unit 211, a data processor 213, and an audio processor 215 connected to a microphone and/or a speaker.

In particular, the RF unit 211 performs a wireless communication function of the portable terminal 101. In greater detail, the RF unit 211 includes a wireless transmitter for up-converting and amplifying a frequency of a transmitted signal and a wireless receiver for low-noise-amplifying a received signal and down-converting a frequency. The data processor 213 includes a transmitter for encoding and modulating the transmitted signal and a receiver for decoding and demodulating the received signal. The data processor 213 may include a MODEM and a CODEC, wherein the codec may include a data CODEC for processing a packet data, or the like, and an audio CODEC for processing audio signals such as a voice, or the like.

The audio processor 215 serves to play the received audio signal output from the data processor 213 through a speaker and performs a function for transmitting the transmitted audio signal generated from a microphone to the data processor 213. The input unit 205 includes keys for inputting alphanumeric data and/or symbols, and function keys for setting various functions. In addition, the display unit 203 displays a video signal on a screen and displays data output from the controller 201.

When the display unit 203 is implemented by a capacitive or resistive type of a touch display screen known in the art, the input unit 205 may include only a predetermined minimum set of input keys, and the display unit 203 may use the touch display screen to substitute and/or complement a part of a key input functions of the input unit 205.

The memory unit 207 includes a program memory and a data memory. The program memory stores a booting and operating system (hereinafter, referred to as “OS”) for controlling general operations of the portable terminal 101, and the data memory stores various types of data that are generated during the operation of the portable terminal 101.

The controller 201 performs functions for controlling general operations of the portable terminal 101. In particular, when payment for a particular product is requested by a user, the controller 201 progresses a product payment process by using the security element server 107.

In greater detail, when the product information is input from the NFC unit 209, the controller 201 displays the product information through the display unit 203 and determines whether payment for a corresponding product is requested by a user. The product information may include a product ID, a product price, and a detailed description of a product.

As a result of the determination, when the payment for the corresponding product is requested, the controller 201 generates a payment request message including an ID of a product for which payment has been requested and an ID of the portable terminal 101 and transmits the generated payment request message to the security element server 107. The ID of the portable terminal 101 refers to a unique ID assigned to or associated with the portable terminal 101 in order to identify the portable terminal 101. For example, the ID of the portable terminal 101 may be a phone number, a Media Access Control (MAC) address, or the like.

When the controller 201 receives a personal identification information request message from the security element server 107 in response to the payment request message, the controller 201 outputs a personal identification information input window through the display unit 203. The personal identification information request message is a message for requesting, from the user, personal identification information for determining whether a user who requests payment is a user of the portable terminal 101.

The controller 201 receives a personal identification number from the user through the personal identification information input window and generates personal identification information including the received personal identification number and then transmits the generated personal identification information to the security element server 107. The personal identification number is a number for identifying a user of the portable terminal 101 and, for example, may be a resident registration number, a pre-populated or pre-stored number, or the like.

The controller 201 receives a payment result message from the security element server 107 and analyzes the received payment result message. The payment result message includes information representing whether payment for a corresponding product has succeeded or failed. According to a result of analysis of the payment result message, the controller 201 outputs, through the display unit 203, whether the payment for the corresponding product has succeeded or failed.

The NFC unit 209 reads product information from the tag 103 and then transmits the product information to the controller 201.

FIG. 3 is a block diagram illustrating an example implementation of a near field communication unit according to the exemplary embodiment of the present invention. Now, an operation of the NFC unit 209 will be described with reference to FIG. 3. Referring to FIG. 3, the NFC unit 209 includes a base band unit 301 and an NFC controller 303.

In particular, the base band unit 301 performs a wireless communication function between the portable terminal 101 and the tag 103. In greater detail, the base band unit 301 includes a wireless transmitter for up-converting and amplifying an RF of a transmitted signal and a wireless receiver for low-noise-amplifying a received signal and down-converting an RF.

The NFC controller 303 performs a function for controlling general operations of the NFC unit 209. In greater detail, the NFC controller 303 recognizes the tag 103 located within a near field communication range. When the tag 103 is recognized, the NFC controller 303 reads product information stored in the tag 103 and outputs the read product information to the controller 201 of the portable terminal 101.

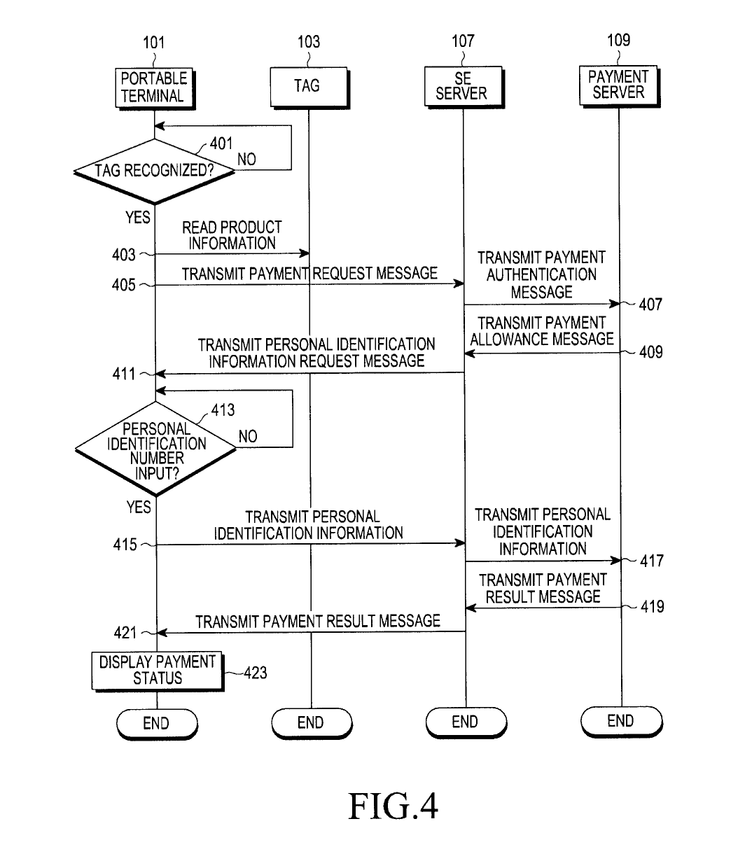

FIG. 4 is a flowchart illustrating a process of performing a payment according to the exemplary embodiment of the present invention.

Referring to FIG. 4, in step 401, the portable terminal 101 determines whether the tag 103 located within a near field communication area or range is recognized. When the tag 103 is recognized, the portable terminal 101 proceeds to step 403, but when the tag 103 is not recognized, the portable terminal 101 repeatedly performs step 401 until the tag 103 is recognized or detected.

In step 403, the portable terminal 101 reads product information previously stored in the tag 103 and then proceeds to step 405. The product information may include a product ID, a product price, and a detailed description of a product. In step 405, when payment for a particular product is requested by a user, the portable terminal 101 generates a payment request message for requesting payment for the corresponding product and transmits the generated payment request message to the security element server 107 and then proceeds to step 407. The payment request message includes an ID of a product for which payment has been requested and an ID of the portable terminal 101.

In step 407, the security element server 107 detects a security element among the preset or pre-stored security elements corresponding to the ID of the portable terminal 101 and included in the payment request message. In addition, the security element server 107 generates a payment authentication message by using user information included in the detected security element and transmits the generated payment authentication message to the payment server 109 and then proceeds to step 409. The payment authentication message may be a message for requesting a payment authentication for the corresponding product and include user information of the portable terminal 101 and a product ID.

In step 409, when the payment server 109 receives the payment authentication message from the security element server 107, the payment server 109 determines whether a payment for a product is allowed based on the user information included in the payment authentication message. When the payment is allowed, the payment server 109 generates a payment allowance message and transmits the generated payment allowance message to the security element server 107 and then proceeds to step 411. The payment allowance message is a message representing that payment for a product for which payment is requested is allowed.

In step 411, when the security element server 107 receives the payment allowance message, the security element server 107 generates a personal identification information request message and transmits the generated personal identification information request message to the portable terminal 101 and then proceeds to step 413. The personal identification information request message is a message for requesting personal identification information and the personal identification information includes information for determining whether a user who requests payment for a product is a user of the portable terminal 101. For example, the personal identification information may be a resident registration number, a pre-populated or pre-stored number, or the like.

In step 413, when the portable terminal 101 receives the personal identification information request message, the portable terminal 101 displays a personal identification information input window and determines whether a personal identification number is input by a user through the displayed personal identification information input window. When the personal identification number is input, the portable terminal 101 proceeds to step 415, but when the personal identification number is not input, the portable terminal 101 repeatedly performs step 413 until the personal identification number is input.

In step 415, the portable terminal 101 generates the personal identification information including the personal identification number and transmits the generated personal identification information to the security element server 107 and then proceeds to step 417. In step 417, the security element server 107 receives the personal identification information and transmits the received personal identification information to the payment server 109 and then proceeds to step 419.

In step 419, when the payment server 109 receives the personal identification information, the payment server 109 determines, by using the personal identification information, whether a user who requests payment is a user of the portable terminal 101. As a result of the determination, when the user who requests payment is the user of the portable terminal 101, the payment server 109 performs payment for a product and transmits a payment result message representing the performed payment result to the security element server 107 and then proceeds to step 421. The payment result message includes information representing that payment for a product for which payment is requested has succeeded or failed.

In step 421, the security element server 107 receives the payment result message and transmits the received payment result message to the portable terminal 101 and then proceeds to step 423. In step 423, when the portable terminal 101 receives the payment result message, the portable terminal 101 analyzes the received payment result message and as a result of the analysis, displays the payment status; that is, whether the payment for the product for which payment is requested has succeeded or failed, and the method in FIG. 4 ends.

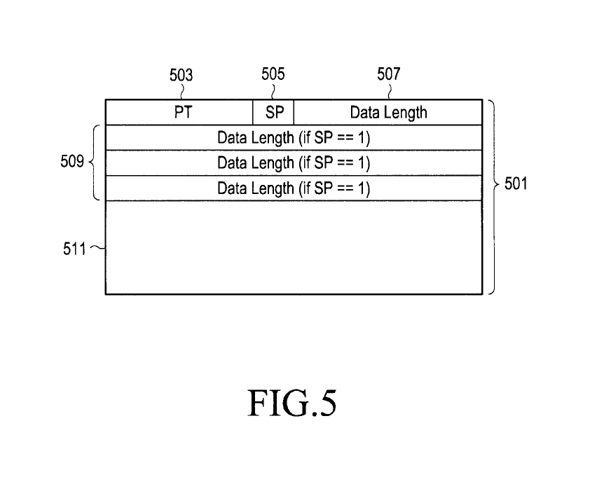

FIG. 5 is a diagram illustrating an example implementation of a protocol data unit according to the exemplary embodiment of the present invention.

Referring to FIG. 5, a Protocol Data Unit (PDU) 501 includes a PDU Type (PT) 503, a Short PDU (SP) 505, Data Lengths 507 and 509, and data fields 511 for storing additional protocol data. The PDU 501 may be used in the messages, for example, transmitted to and from the portable terminal 101, the security element server 107, and the payment server 109.

In particular, PT 503 represents a PDU type. For example, when the PT 503 is configured to have 3 bits, in the case in which the PT 503 is “000”, the PDU 501 may be a payment request message, while in the case in which the PT 503 is “001”, the PDU 501 may be a personal identification information request message, and in the case in which the PT 503 is “010”, the PDU 501 may be a message including personal identification information, and in addition, in the case in which the PT 503 is “011”, the PDU 501 may be a payment result message.

In addition, the SP 505 is a flag value which is set depending on the data length. For example, when the SP 505 is configured to have 1 bit, in the case in which the SP 505 is “0”, the data in the data field 511 is less than a preset byte size and in the case in which the SP 505 is “1”, the data in the data field 511 is more than a preset byte size. For example, the preset byte may be 16 bytes.

The data lengths 507 and 509 represent a length of the SP 505. For example, in the case in which the SP 505 is “0”, the data length 507 may be represented by using 4 bits and in the case in which the SP 505 is “1”, the data lengths 507 and 509 be represented by using 4 bits and 3 bytes, respectively.

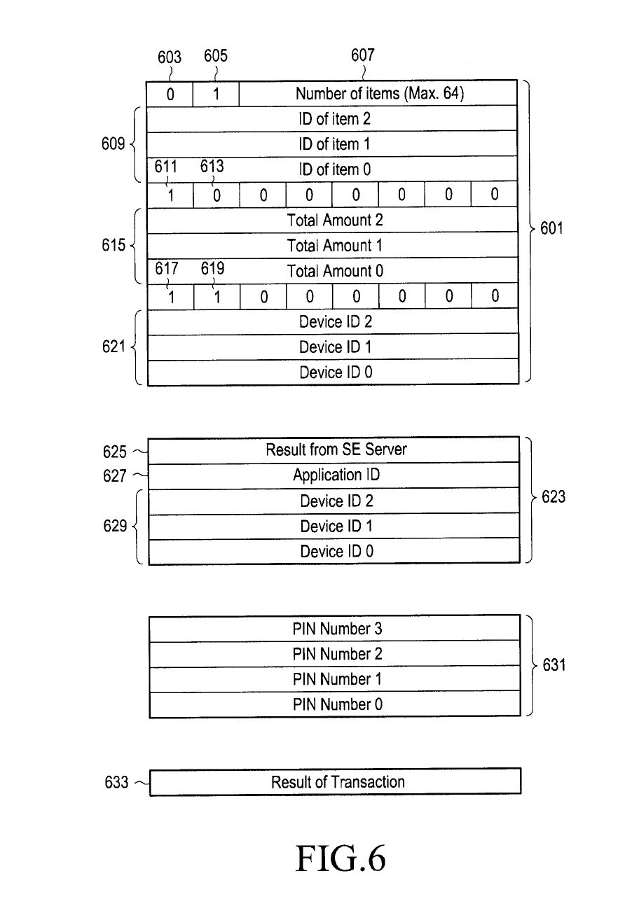

FIG. 6 is a diagram illustrating an example implementation of data for each message, for example, sent to and from the portable terminal 101, the security element server 107, and the payment server 109 according to the exemplary embodiment of the present invention.

Referring to FIG. 6, when the PDU 501 in FIG. 5 is a payment request message, data 601 includes an ID of a product to be purchased, information regarding the number of purchased products, information on total charges to be paid, and a device ID. For example, when the record type (RT) is “01”, as specified by the data fields 603 and 605, the data 601 includes the information 607 regarding the number of purchased products or items, and a product ID 609 for each purchased item in the RT data fields 603 and 605, when the RT is “10” as specified in the data fields 611 and 613, the data 601 includes information on the total charges to be paid, specified in the data field 615 for each total charge amount in the RT data fields 611 and 613, and when the RT is “11” as specified in the data fields 617 and 619, the data 601 may include the device ID for each item in the RT fields 617 and 619. The information 607 of the number of products or purchased items may represent the number of identical products and be configured to have 6 bits. When the number of product information 607 is configured to have 6 bits, the maximum number of identical products may be a predetermined maximum; for example, 64.

When the PDU 501 in FIG. 5 is a personal identification information request message, data 623 in FIG. 6 includes payment authentication result information 625 and application IDs and device IDs 627 and 629 from the security element server 107. In greater detail, the result information represents that the security element server 107 causes a payment authentication to succeed or fail by using a security element of the portable terminal 101, and the application ID represents an ID for launching an application for progressing payment such as personal identification information or the like.

When the PDU 501 in FIG. 5 is a message including personal identification information, the data 631 in FIG. 6 includes at least one or more security identification numbers, such as PINS. In addition, when the PDU 501 is a payment result message, the data 633 includes information representing a payment result as the result of a transaction.

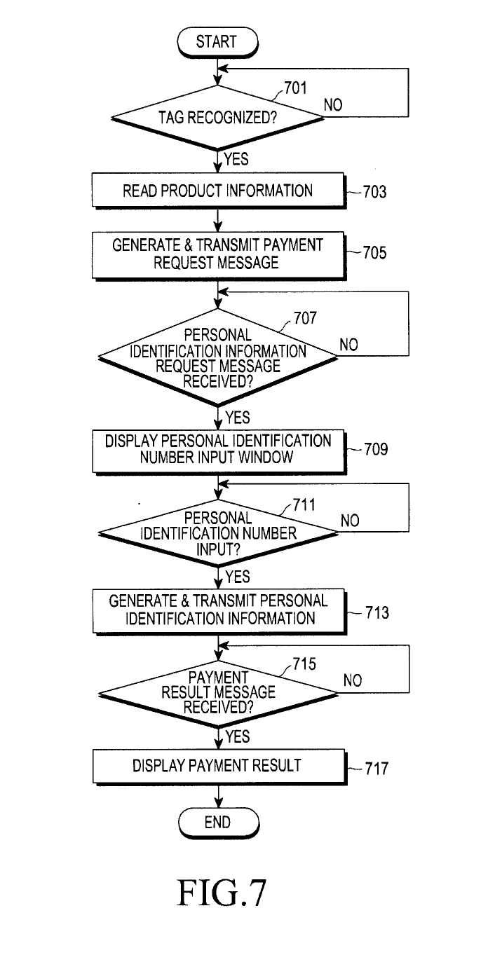

FIG. 7 is a flowchart illustrating a process by which the portable terminal 101 pays for a product according to the exemplary embodiment of the present invention.

Referring to FIG. 7, in step 701, the portable terminal 101 determines whether a tag 103 located within a predetermined near field communication range is recognized. When the tag 103 is recognized, the portable terminal 101 proceeds to step 703, but when the tag 103 is not recognized, the portable terminal 101 repeatedly performs step 701 until the tag 103 is detected and recognized.

In step 703, the portable terminal 101 reads product information previously stored in the tag 103 and then proceeds to step 705. The product information may include a product ID, a product price, and a detailed description of a product. In step 705, when payment for a particular product is requested by a user, the portable terminal 101 generates a payment request message for requesting payment for the corresponding product and transmits the generated payment request message to the security element server 107 and then proceeds to step 707. The payment request message includes an ID of a product for which payment is requested and an ID of the portable terminal 101.

In step 707, the portable terminal 101 determines whether a personal identification information request message is received. When the personal identification information request message is received, the portable terminal 101 proceeds to step 709, but when the personal identification information request message is not received, the portable terminal 101 repeatedly performs step 707 until the personal identification information request message is received.

In step 709, the portable terminal 101 displays a personal identification information input window and, in step 711, determines whether a personal identification number is input by a user through the displayed personal identification information input window. When the personal identification number is input, the portable terminal 101 proceeds to step 713, but when the personal identification number is not input, the portable terminal 101 repeatedly performs step 711 to detect for input of the personal identification number. The personal identification information request message is a message for requesting personal identification information and the personal identification information includes information on determining whether a user who requests payment for a product is a user of the portable terminal 101.

In step 713, the portable terminal 101 generates personal identification information including a personal identification number and transmits the generated personal identification information to the security element server 107 and then proceeds to step 715. In step 715, the portable terminal 101 determines whether a payment result message is received. When the payment result message is received, the portable terminal 101 proceeds to step 717, but when the payment result message is not received, the portable terminal 101 repeatedly performs step 715 until the payment result message is received. The payment result message includes information representing whether payment for a product for which payment is requested has succeeded or failed.

In step 717, the portable terminal 101 analyzes the received payment result message and as a result of the analysis, displays whether payment for a product for which payment is requested has succeeded or failed. The method in FIG. 7 then ends.

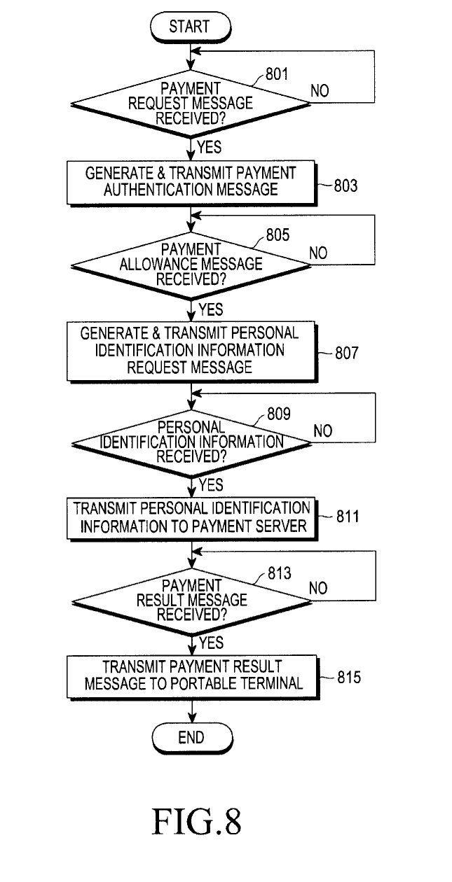

FIG. 8 is a flowchart illustrating a process by which the security element server 107 pays for a product according to the exemplary embodiment of the present invention.

Referring to FIG. 8, in step 801, the security element server 107 determines whether a payment request message is received from the portable terminal 101. When the payment request message is received, the security element server 107 proceeds to step 803, but when the payment request message is not received, the security element server 107 repeatedly performs step 801 until the payment request message is received. The payment request message is a message for requesting payment for a product for which payment is requested and includes an ID of a product for which payment is requested and an ID of the portable terminal 101.

In step 803, the security element server 107 detects a security element among the preset or pre-stored security elements corresponding to the ID of the portable terminal 101 included in a payment request message. The security element server 107 generates a payment authentication message by using user information included in the detected security element and transmits the generated payment authentication message to the payment server 109 and then proceeds to step 805. The payment authentication message may be a message for requesting a payment authentication of the corresponding product and include user information of the portable terminal 101 and a product ID.

In step 805, the security element server 107 determines whether a payment allowance message is received from the payment server 109. As a result of the determination, when the payment allowance message is received, the security element server 107 proceeds to step 807, but when the payment allowance message is not received, the security element server 107 repeatedly performs step 805 until the payment allowance message is received.

In step 807, the security element server 107 generates a personal identification information request message and transmits the generated personal identification information request message to the portable terminal 101 and then proceeds to step 809. The personal identification information request message is a message for requesting personal identification information and the personal identification information includes information for determining whether a user who requests payment for a product is a user of the portable terminal 101. For example, the personal identification information may be a resident registration number, a pre-populated or pre-stored number, or the like.

In step 809, the security element server 107 determines whether personal identification information is received. As a result of the determination, when the personal identification information is received, the security element server 107 proceeds to step 811, but when the personal identification information is not received, the security element server 107 repeatedly performs step 809 until the personal identification information is received. In step 811, the security element server 107 transmits the received personal identification information to the payment server 109 and then proceeds to step 813.

In step 813, the security element server 107 determines whether a payment result message is received from the payment server 109. The payment result message includes information representing that payment for a product for which payment is requested has succeeded or failed. As a result of the determination, when the payment result message is received, the security element server 107 proceeds to step 815, but when the payment result message is not received, the security element server 107 repeatedly performs step 813 until the payment result message is received. In step 815, the security element server 107 transmits the received payment result message to the portable terminal 101, and the method in FIG. 8 then ends.

In the exemplary embodiment of the present invention, step 801 to step 815 in FIG. 8 may be performed by a controller of the security element server 107 and security elements of the portable terminal 101 may be stored in a memory unit of the security element server 107.

The present invention pays for a product by using a security element server for storing security elements of a plurality of portable terminals, and thus has an effect capable of performing payment for a product even though a near field communication device does not store a security element.

The above-described apparatus and methods according to the present invention can be implemented in hardware, firmware or as software or computer code that can be stored in a non-transitory recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any medium such as communication signals transmitted by wire/wireless connections, and their equivalents. The computer readable recording medium can also be distributed in network coupled computer systems so that the computer readable code is stored and executed in a distributed fashion.

While the invention has been shown and described with detailed embodiments such as a wireless terminal, it will be understood by those skilled in the art that various changes in form and details may be made therein without departing from the spirit and scope of the invention as defined by the appended claims.

What is claimed is:

1. An apparatus for paying for a product using a near field communication device, the apparatus comprising:
a controller, communicating with the near field communication device, for generating a payment request message for requesting payment for the product and then transmitting the payment request message to a security element server when payment for the product is requested, receiving an input of personal identification information and transmitting the input personal identification information to the security element server when a personal identification information request message for requesting personal identification information in response to the payment request message is received, and receiving a payment result message representing a result of the payment.

2. The apparatus of claim 1, wherein the payment request message comprises a unique ID of the product and a unique ID of the apparatus.

3. The apparatus of claim 1, wherein the personal identification information request message comprises an application ID for performing the payment and information representing an authentication result of the payment.

4. The apparatus of claim 1, wherein the payment result message comprises information representing whether the payment has succeeded or failed.

5. An apparatus for paying for a product using a near field communication device, the apparatus comprising:
a memory unit for storing security elements corresponding to a plurality of portable terminals, and
a controller for detecting a security element among the stored security elements, with the detected security element corresponding to a specific portable terminal of the plurality of portable terminals, and determining whether the payment for the product is authorized by using the detected security element when a payment request message for requesting payment for the product is received from the specific portable terminal, transmitting a personal identification information request message for requesting personal identification information to the specific portable terminal when an authentication of payment is determined, progressing payment for the product by using the personal identification information when the personal identification information is received, and transmitting a payment result message representing a result of the progressed payment to the specific portable terminal.

6. The apparatus of claim 5, wherein the payment request message comprises a unique ID of the product and a unique ID of the specific portable terminal.

7. The apparatus of claim 5, wherein the personal identification information request message comprises an application ID for performing the payment and information representing an authentication result of the payment.

8. The apparatus of claim 5, wherein the payment result message comprises information representing whether the payment has succeeded or failed.

9. A method of paying for a product using a near field communication device, the method comprising:
when payment for the product is requested, generating a payment request message for requesting payment for the product and transmitting the payment request message to a security element server;
when a personal identification information request message for requesting personal identification information in response to the payment request message is received, receiving an input of personal identification information;
transmitting the input personal identification information to the security element server; and
receiving a payment result message representing a result of the payment.

10. The method of 9, wherein the payment request message comprises a unique ID of the product and a unique ID of a portable terminal including the near field communication device.

11. The method of claim 9, wherein the personal identification information request message comprises an application ID for performing the payment and information representing an authentication result of the payment.

12. The method of claim 9, wherein the payment result message comprises information representing whether the payment has succeeded or failed.

13. A method of paying for a product using a near field communication device, the method comprising:
when a payment request message for requesting payment for the product is received from a portable terminal including the near field communication device, detecting a security element corresponding to the portable terminal among previously stored security elements;
determining whether the payment is authorized by using the detected security element;
when the authentication of payment is determined, transmitting a personal identification information request message for requesting personal identification information to the portable terminal;
when the personal identification information is received, progressing payment for the product by using the personal identification information; and
transmitting a payment result message representing a result of the progressed payment to the portable terminal.

14. The method of 13, wherein the payment request message comprises a unique ID of the product and a unique ID of the portable terminal.

15. The method of claim 13, wherein the personal identification information request message comprises an application ID for performing the payment and information representing an authentication result of the payment.

16. The method of claim 13, wherein the payment result message comprises information representing whether the payment has been or failed.
